(19) United States
(12) Patent Application Publication
(10) Pub. No.: US 2026/0251268 A1
(43) Pub. Date: Aug. 27, 2026

(54) METHOD AND FACILITY FOR TRANSFERRING CRYOGENIC LIQUID

(71) Applicant: L'Air Liquide, Societe Anonyme pour l'Etude et l’Exploitation des Procedes Georges Claude, Paris (FR)

(72) Inventor: Pierre BENICHOU, Paris (FR)

(21) Appl. No.: 19/544,770

(22) Filed: Feb. 19, 2026

(30) Foreign Application Priority Data
Feb. 21, 2025 (FR) FR2501829

(51) Int. Cl. F17C 7/02

(52) U.S. Cl. CPC F17C 7/02; F17C 2205/0326; F17C 2205/0352; F17C 2221/012; F17C 2223/0161; F17C 2227/0135; F17C 2250/043; F17C 2250/0439; F17C 2250/0443; F17C 2250/0636; F17C 2250/0694; F17C 2265/063

(57) ABSTRACT

The invention relates to a method and a facility for transferring cryogenic liquid from a source tank to a receiving store in which a first pipe connects the lower part of the source tank to the receiving store and a second pipe connects the upper part of the receiving store to the source tank, the first pipe having a pump, the second pipe comprising a valve, the method comprising, prior to and/or simultaneously with a step of transferring liquid from the source tank to the receiving store, a step of transferring gas from the receiving store to the source tank in order to ensure a given pressurization of the source tank, the gas transfer step involving adjusting the flow rate of gas transferred via the second pipe in order to limit the quantity of energy transferred to the source tank below a given threshold.

### CROSS REFERENCE TO RELATED APPLICATIONS

This application claims the benefit of priority under 35 U.S.C. § 119 (a) and (b) to French patent application No. FR 2501829, filed Feb. 21, 2025, which is herein incorporated by reference in its entirety.

### FIELD OF THE INVENTION

The invention relates to a method and a facility for transferring cryogenic liquid, for example liquid hydrogen.

### BACKGROUND OF THE INVENTION

The process of delivering liquefied hydrogen generally uses a gas connection pipe to keep the source tank pressurized. This gas return pipe transfers the gas from the receiving store to the source tank while a pump transfers the liquid from the source to the receiving store.

Depending on the configuration of the facility, the gas conveyed to the source tank may be heated (a poorly insulated gas pipe, for example). Large quantities of hot gas sent into the source tank cause the liquid hydrogen in the source tank to heat up. This reduces the efficiency of the supply chain.

However, a minimum quantity of gas sent into the source tank is necessary in order to keep the source tank pressurized. This is because this pressurization allows the pump to operate optimally and prevents the liquid hydrogen from reaching a thermodynamic state (too low subcooling), which would cause cavitation (“net positive suction head” or “NPSH”).

Known delivery processes are unsatisfactory because they generate excessive temperature rises of the source tank and/or do not allow optimal operation of the liquid pump.

### SUMMARY OF THE INVENTION

In certain embodiments, the invention relates more particularly to a method for transferring cryogenic liquid, for example liquid hydrogen, from a source tank to a receiving store in which a first pipe connects the lower part of the source tank to the receiving store and a second pipe connects the upper part of the receiving store to the source tank, the first pipe having a pump and being configured to transfer liquid from the source tank to the receiving store, the second pipe comprising a valve and being configured to transfer gas from the receiving store to the source tank, the method comprising, prior to and/or simultaneously with a step of transferring liquid from the source tank to the receiving store, a step of transferring gas from the receiving store to the source tank in order to ensure a given pressurization of the source tank.

One aim of the present invention is to overcome all or some of the abovementioned drawbacks of the prior art.

To this end, the method according to the invention is configured such that the step of transferring gas from the receiving store to the source tank involves adjusting the flow rate of gas transferred via the second pipe in order to limit the quantity of energy transferred to the source tank below a given threshold.

In certain embodiments, the invention makes it possible to control the quantity of gas sent into the source tank in order to achieve sufficient pressurization therein, while limiting heating in order to increase the efficiency of deliveries.

Furthermore, embodiments of the invention may have one or more of the following features:
the adjustment of the flow rate of gas transferred via the second pipe is configured to limit the increase in temperature of the fluid in the source tank below a given level,
the adjustment of the flow rate of gas transferred via the second pipe is configured to limit the increase in the energy of the fluid in the source tank below a given level,
the adjustment of the flow rate of gas transferred via the second pipe is configured to keep subcooling at the inlet of the pump above a given level,
the valve of the second pipe is of the progressive opening type, the adjustment of the flow rate of gas transferred being carried out by controlling the degree of opening of the valve,
the method involves the measurement and/or calculation of the following thermodynamic variables: the pressure in the upper part of the source tank, the pressure in the upper part of the receiving store, the temperature of the gas at the end of the second pipe connected to the source tank, the flow rate of gas in the second pipe, the pressure at the inlet of the pump, the temperature of the gas at the inlet of the pump,
the degree of opening of the valve is controlled depending on the measured or calculated values of the thermodynamic variables,
the method comprises a step of calculating the mass and/or the amount of enthalpy supplied to the source tank via the flow of gas circulating in the second pipe by using all or some of the measured or calculated values of the thermodynamic variables, the degree of opening of the valve being controlled depending on the cumulative mass and/or the cumulative amount of enthalpy supplied to the source tank over a given period of time.

The invention also relates to a facility for transferring cryogenic liquid, for example liquid hydrogen, comprising a source tank and a receiving store, the facility comprising a first pipe connecting the lower part of the source tank to the receiving store and a second pipe connecting the upper part of the receiving store to the source tank, the first pipe having a pump and being configured to transfer liquid from the source tank to the receiving store, the second pipe comprising a valve and being configured to transfer gas from the receiving store to the source tank, the facility comprising a set of members for measuring or determining at least some of the following thermodynamic variables: the pressure in the upper part of the source tank, the pressure in the upper part of the receiving store, the temperature of the gas at the end of the second pipe connected to the source tank, the flow rate of gas in the second pipe, the pressure at the inlet of the pump, the temperature of the gas at the inlet of the pump, the facility comprising an electronic control member for data acquisition and processing configured to control a flow rate adjustment member of the facility that is configured to adjust the flow rate of the gas transferred via the second pipe, in order to limit the quantity of energy transferred to the source tank below a given threshold.

According to other possible particular features:
the control member is configured to keep subcooling at the inlet of the pump below a given level by adjusting the flow rate of the gas transferred via the second pipe, via the adjustment member,
the flow rate adjustment member is the valve of the second pipe, said valve being of the progressive opening type.

The invention may also relate to any alternative device or method comprising any combination of the features above or below within the scope of the claims.

Further particular features and advantages will become apparent upon reading the following description, which is provided with reference to the figures, in which:

### BRIEF DESCRIPTION OF THE DRAWINGS

The invention will be understood more clearly from reading the following description and from studying the accompanying figures. These figures are given only by way of illustration and do not in any way limit the invention.

FIG. 1 is a schematic and partial view illustrating the structure and operation of a first exemplary embodiment of the invention,

FIG. 2 is a schematic and partial view illustrating the structure and operation of a second exemplary embodiment of the invention.

FIG. 3 is a schematic and partial view illustrating an example of steps that can be implemented by the invention.

### DETAILED DESCRIPTION OF THE INVENTION

Throughout the figures, the same reference signs relate to the same elements.

In this detailed description, the following embodiments are examples. Although the description refers to one or more embodiments, this does not mean that the features apply only to a single embodiment. Individual features of different embodiments can also be combined and/or interchanged in order to provide other embodiments.

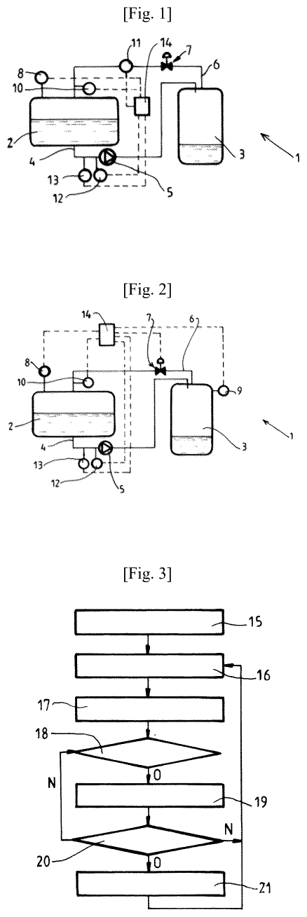

FIG. 1 illustrates a first example of a facility 1 for transferring cryogenic liquid that can implement the invention, for example for the delivery of liquid hydrogen.

The installation 1 comprises a (for example mobile) source tank 2 (on a vehicle or a boat) and a (for example fixed or mobile) receiving store 3 (of a factory or station or of a vehicle).

The installation 1 comprises a first pipe 4 connecting the lower part of the source tank 2 to the receiving store 3 (preferably in the upper part) and a second pipe 6 connecting the upper part of the receiving store 3 to the source tank 2 (preferably in the upper part).

The first pipe 4 comprises a cryogenic pump 5 configured to transfer liquid from the source tank 2 to the receiving store 3.

The second pipe 6 comprises a flow rate adjusting member, preferably a variable opening valve 7 configured to transfer gas from the receiving store 3 to the source tank 2.

The facility 1 comprises a set of members for measuring or determining at least some of the following thermodynamic variables: the pressure 8 in the upper part of the source tank 2, the pressure 9 in the upper part of the receiving store 3, the temperature 10 of the gas at the end of the second pipe 6 connected to the source tank 2, the flow rate 11 of gas in the second pipe 6, the pressure 12 at the inlet of the pump 5, the temperature 13 of the gas at the inlet of the pump 5.

In the example shown, the facility 1 comprises a sensor 8 measuring the pressure in the upper part of the source tank 2, a sensor 9 measuring the pressure in the upper part of the receiving store 3 (headspace), a sensor 10 measuring the temperature of the gas at the end of the second pipe 6 connected to the source tank 2, a flow meter 11 measuring the gas flow rate in the second pipe 6, a sensor 12 measuring the pressure at the inlet of the pump 5, and a sensor 13 measuring the temperature 13 of the gas at the inlet of the pump 5.

The facility 1 also comprises an electronic control member 14 for acquiring and processing data (comprising, for example, a microprocessor). This control member 14 is configured to receive the measurements from the abovementioned sensor or sensors and to control, depending on these measurements, the flow rate adjustment valve 7 (which is controllable) so as to limit the quantity of energy transferred to the source tank 2 (for example below a given threshold).

For example, the control member 14 can control the opening of the valve 7 on the second gas pipe 6 (for example from 0 to 100%) dynamically depending on the abovementioned measurements.

For example, a predefined thermodynamic model can determine the maximum permitted admission of gas mass and enthalpy into the source tank 2 through the second pipe 6 and the control member 14 can calculate these data during filling.

This can define, for example, a maximum quantity of enthalpy of the gas not to be exceeded.

Of course, alternatively to enthalpy, parameters other than enthalpy can be taken into consideration in order to control this return of gas to achieve filling efficiency.

The measurement 10 of the temperature of the transferred gas entering the source tank 2 (and preferably also the measurement of the pressure at the outlet of the second pipe 6) and also the measurement 11 of the flow rate in this second pipe 6 make it possible to calculate the actual enthalpy of the gas which is supplied to the source tank 2. This value can be compared with a given target enthalpy value.

The enthalpy value transferred into the source tank 2 can thus be adjusted by controlling the opening of the valve 7.

In this control process, the pressure 12 and optionally the temperature 13 at the inlet of the pump 5 can be measured and monitored to ensure that the available NPSH (inlet pressure drop or “cavitation pressure margin”) of the pump 5 does not fall below a minimum required NPSH level determined for proper operation of pump 5 (to avoid cavitation).

The efficiency or effectiveness of a supply chain using the source tank 2 to successively fill several separate stores is dependent on the saturation pressure Psat and on the remaining mass mr at the end of delivery.

The saturation pressure Psat and the remaining fluid mass depend on the density and the internal energy in the source tank 2 after fluid transfer.

The density ρf (in kg per m3) and the internal mass energy uf (in J/kg) within the source tank 2 after filling can be calculated as follows:

$$ρ f = ( Mi + Mg - Ml ) / V = Mr / V$$

where

Mi is the initial mass of fluid in the source tank 2 before transfer (in kg)

Mg is the mass of gas transferred from the store 3 to the source tank 2 during filling (in kg)

Ml is the mass of liquid transferred from the source tank 2 to the store 3 during filling (in kg)

V is the volume of the source tank 2 (in m3).

$$uf = ( Ui + Hg - Hl ) / ( Mi + Mg - Ml )$$

uf being the internal mass energy after filling (in Joules per kg)

Ui being the total internal energy of the fluids (liquid+gas) in the source tank 2 before filling (in Joules)

Hg the enthalpy of the gas transferred to the source tank 2 during filling (in Joules)

Hl the enthalpy of the liquid transferred out of the source tank 2 during filling (in Joules)

Mi the initial mass of fluid in the source tank 2 before transfer (in kg)

Mg the mass of gas transferred from the store 3 to the source tank 2 during filling (in kg)

Ml the mass of liquid transferred from the source tank 2 to the store 3 during filling (in kg)

The saturation pressure depends on the density ρf and on the internal energy density uf.

Thus, by controlling Mg and Hg (which depend on the flow rate coefficient Cv of the second pipe 6), it is therefore possible to control the saturation pressure and thus the effectiveness or efficiency of the supply chain. Specifically, in practice, Mg and Hg are impacted by the flow rate coefficient in the second pipe 6.

The “negative suction pressure” (or “cavitation pressure margin”) “NPSH” (in metres of fluid column mfc)=Pi−PS(Ti)

where Pi is the pressure measured at the inlet of the pump 5, Ti is the temperature measured at the inlet of the pump 5 and Ps(Ti)=the saturating pressure of the fluid calculated at the temperature Ti (for example via a predetermined table).

Thus, the example in FIG. 1 makes it possible to control the energy supplied to the source tank 2 during filling by the transfer of gas in the second pipe 6.

The variant in FIG. 2 is distinguished by the fact that the flow meter is omitted on the second pipe 6. This is because a flow meter is not necessary if it can be calculated, for example, from the known flow rate coefficient Cv of said pipe 6 depending on the opening of the valve 7.

In the embodiment in FIG. 2 a pressure sensor 9 measures the pressure in the headspace of the receiving store 3.

It should be noted that, according to other possible configurations, the measurement 10 of the temperature of the gas in the second pipe 6 could be omitted. For example, this temperature value could be calculated from a model, for example a predictive model, based on the measured pressure values. This model can be based on predetermined correlations or hypotheses (for example a saturated state in the source tank 2).

One possible example of a process according to the invention will be described with reference to FIG. 3.

In a first step 15, for example before filling, a maximum quantity of enthalpy that the source tank 2 can receive can be determined. This maximum quantity of enthalpy can be calculated, for example, to satisfy a given delivery efficiency or effectiveness.

In a subsequent step 16, during filling, the amount of enthalpy of the gas sent into the source tank 2 can be calculated at any time as described above, for example from the measurement of the flow rate, the temperature and the pressure of the gas).

The enthalpy caused by the gas flow arriving in the source tank 2 is calculated 17 and compared with the maximum quantity of enthalpy.

If, during the calculation and the comparison 18 the allowed enthalpy remains less than the maximum quantity of enthalpy (N), filling continues until its completion.

If this cumulative enthalpy exceeds the maximum quantity of enthalpy (O), then the flow rate in the second pipe 6 can be limited (for example via the valve 7). Then, the process can calculate and compare 20 the NPSH with the minimum threshold required. If this NPSH is too low (O), the valve 7 (or the like) can be activated 21 to increase this NPSH at the inlet of the pump 5.

If the NPSH at the inlet of the pump 5 drops below a safety limit, defined for example as the required NPSH of the pump 5 and multiplied by a safety factor for example, the valve 7 can be actuated to increase the enthalpy flow rate of the gas.

Thus, at any time, the current amount of enthalpy (or energy) of the gas can be calculated or estimated from the measurements of the thermodynamic variables of the facility 1.

By knowing the remaining time for the remaining transfer (filling) and having calculated the enthalpy or energy that has already accumulated in the source tank 2, the current transferred amount of enthalpy can be compared with the maximum objective in order to achieve the required supply chain efficiency. In operation, the valve 7 can be actuated to reduce the enthalpy flow rate of the gas entering the source tank 2.

In one possible variant, it is possible to take into account the variable thermal input of the pump 5 by measuring, for example, the pressure and the temperature at the outlet of the pump 5.

The speed of the pump 5 may, for example, be adapted to keep the value of the heat input at or adapt it to the flow rate of fluid pumped.

In addition, the valve 7 and the pump speed can be actuated as an additional step if the flow rate of the pump 5 drops below a minimum required to ensure a certain speed of delivery.

The invention makes it possible to ensure a high mass efficiency of the supply chain by limiting the heating of the liquid hydrogen in the source tank 2 during successive deliveries while maintaining sufficient NPSH for the pump 5.

The invention also makes it possible to limit the quantity of gas transferred to the source tank 2 by limiting the supply of gas from the store 3 to what is strictly necessary for pressurizing the pump 5.

In addition, the gas transferred from the store 3 to source tank 2 decreases the saturation pressure in the store 3 and increases the saturation pressure in the source tank 2.

The invention makes it possible to manage a compromise between the saturation pressure achieved in the store 3 to be filled and the efficiency of the supply chain with the source tank 2.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims. The present invention may suitably comprise, consist or consist essentially of the elements disclosed and may be practiced in the absence of an element not disclosed. Furthermore, if there is language referring to order, such as first and second, it should be understood in an exemplary sense and not in a limiting sense. For example, it can be recognized by those skilled in the art that certain steps can be combined into a single step.

The singular forms “a”, “an” and “the” include plural referents, unless the context clearly dictates otherwise.

“Comprising” in a claim is an open transitional term which means the subsequently identified claim elements are a nonexclusive listing (i.e., anything else may be additionally included and remain within the scope of “comprising”). “Comprising” as used herein may be replaced by the more limited transitional terms “consisting essentially of” and “consisting of” unless otherwise indicated herein.

“Providing” in a claim is defined to mean furnishing, supplying, making available, or preparing something. The step may be performed by any actor in the absence of express language in the claim to the contrary.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

1. A method for transferring cryogenic liquid from a source tank to a receiving store in which a first pipe connects the lower part of the source tank to the receiving store and a second pipe connects the upper part of the receiving store to the source tank, the first pipe having a pump and being configured to transfer liquid from the source tank to the receiving store, the second pipe comprising a valve and being configured to transfer gas from the receiving store to the source tank, the method comprising the steps of:
a) transferring liquid from the source tank to the receiving store; and
b) transferring gas from the receiving store to the source tank in order to ensure a given pressurization of the source tank,
wherein the step of transferring gas from the receiving store to the source tank involves adjusting a flow rate of gas transferred via the second pipe in order to limit the quantity of energy transferred to the source tank below a given threshold,
wherein step b) occurs prior to and/or simultaneously with step a).

2. The method according to claim 1, wherein the cryogenic liquid is liquid hydrogen.

3. The method according to claim 1, wherein the adjustment of the flow rate of gas transferred via the second pipe is configured to limit the increase in temperature of the fluid in the source tank below a given level.

4. The method according to claim 1, wherein the adjustment of the flow rate of gas transferred via the second pipe is configured to limit the increase in the energy of the fluid in the source tank below a given level.

5. The method according to claim 1, wherein the adjustment of the flow rate of gas transferred via the second pipe is configured to keep subcooling at the inlet of the pump above a given level.

6. The method according to claim 1, wherein the valve of the second pipe is of the progressive opening type, the adjustment of the flow rate of gas transferred being carried out by controlling the degree of opening of the valve.

7. The method according to claim 1, wherein the method further comprises measuring and/or calculating thermodynamic variables selected from the group consisting of: the pressure in the upper part of the source tank, the pressure in the upper part of the receiving store, the temperature of the gas at the end of the second pipe connected to the source tank, the flow rate of gas in the second pipe, the pressure at the inlet of the pump, the temperature of the gas at the inlet of the pump, and combinations thereof.

8. The method according to claim 6, wherein the degree of opening of the valve is controlled depending on the measured or calculated values of the thermodynamic variables.

9. The method according to claim 8, further comprising calculating the mass and/or the amount of enthalpy supplied to the source tank via the flow of gas circulating in the second pipe by using all or some of the measured or calculated values of the thermodynamic variables, the degree of opening of the valve being controlled depending on the cumulative mass and/or the cumulative amount of enthalpy supplied to the source tank over a given period of time.

10. A facility for transferring cryogenic liquid comprising liquid hydrogen, the facility comprising:
a source tank and a receiving store;
a first pipe connecting the lower part of the source tank to the receiving store and a second pipe connecting the upper part of the receiving store to the source tank, the first pipe having a pump and being configured to transfer liquid from the source tank to the receiving store, the second pipe comprising a valve and being configured to transfer gas from the receiving store to the source tank; and
a set of members configured to measure or determine a thermodynamic variable selected from the group consisting of: the pressure in the upper part of the source tank, the pressure in the upper part of the receiving store, the temperature of the gas at the end of the second pipe connected to the source tank, the flow rate of gas in the second pipe, the pressure at the inlet of the pump, the temperature of the gas at the inlet of the pump, the facility comprising an electronic control member for data acquisition and processing configured to control a flow rate adjustment member of the facility that is configured to adjust the flow rate of the gas transferred via the second pipe, in order to limit the quantity of energy transferred to the source tank below a given threshold.

11. The facility according to claim 10, wherein the control member is configured to keep subcooling at the inlet of the pump below a given level by adjusting the flow rate of the gas transferred via the second pipe, via the adjustment member.

12. The facility according to claim 10, wherein the flow rate adjustment member is the valve of the second pipe, said valve being of the progressive opening type.
